(19) United States
(12) Patent Application Publication
(10) Pub. No.: US 2020/0054936 A1
(43) Pub. Date: Feb. 20, 2020

(54) DEVICE AND METHOD FOR DROPPING BALL AND NON-TRANSITORY COMPUTER-READABLE MEDIUM

(71) Applicant: INTERNATIONAL GAMES SYSTEM CO., LTD., New Taipei City (TW)

(72) Inventor: Ko-Fu LIN, New Taipei City (TW)

(21) Appl. No.: 16/378,589

(22) Filed: Apr. 9, 2019

(30) Foreign Application Priority Data
Aug. 17, 2018 (CN) 201810942134.3

(51) Int. Cl. A63F 7/02; A63F 13/52

(52) U.S. Cl. CPC A63F 7/022; A63F 13/52

(57) ABSTRACT

A device and method for dropping ball and non-transitory computer-readable medium are provided in this disclosure. The device includes a launcher, a display and a processor. The launcher is configured to launch a first ball according to a control signal. The display is configured to display a gameplay frame. The processor is configured to transmit the control signal to the launcher according to a trigger signal, wherein, when the first ball dropped into a trigger unit when the launcher is launches the first ball; the trigger unit is configured to transmit a dropping ball result to the processor, and the processer is configured to transmit the gameplay frame to the display according to the dropping ball result.

### CROSS-REFERENCE TO RELATED APPLICATION

This application claims priority to Chinese Application Serial Number 201810942134.3, filed on Aug. 17, 2018, which is herein incorporated by reference.

### BACKGROUND

### Field of Invention

The present application relates to a device and method for dropping ball and non-transitory computer-readable medium. More particularly, the present application relates to an electronic device integrating a method and system for dropping ball in the gaming machine.

### Description of Related Art

Recently, the development of game machines grow flourishing, more and more consumer choose to go to playground to play and consume. In order to make the consumers gain better game playing experience and attract them, the developers combine electronic device and the gaming machine and that would elevate the consumers' amusing experience through the game condition of electronic device which is triggered by manipulating the electronic device.

### SUMMARY

An aspect of the disclosure is to provide a dropping ball device. The device includes a launcher, a display and a processor. The processor is electrically coupled to the display and the launcher. The launcher is configured for launching a first ball according to a control signal. The display is configured for displaying a gameplay frame. The processor is configured for transmitting the control signal to the launcher according to a trigger signal, wherein, the first ball dropped into a trigger unit when the launcher is launches the first ball; the trigger unit is configured to transmit a dropping ball result to the processor, and the processer is configured to transmit the gameplay frame to the display according to the dropping ball result.

Another aspect of the disclosure is to provide a method for dropping ball. The method includes operations of: transmitting a control signal to a launcher according to a trigger signal by a processor; launching a first ball according to the control signal by the launcher; when the first ball dropped into a trigger unit, transmitting a dropping ball result to the processor by the trigger unit; and transmitting a gameplay frame to a display according to the dropping ball result by the processor.

Another aspect of the disclosure is to provide a non-transitory computer-readable medium including one or more sequences of instructions to be executed by a processor of a device for performing a method for dropping ball, wherein the method includes operations of: transmitting a control signal to a launcher according to a trigger signal by a processor; launching a first ball according to the control signal by the launcher; when the first ball dropped into a trigger unit, transmitting a dropping ball result to the processor by the trigger unit; and transmitting a gameplay frame to a display according to the dropping ball result by the processor.

It is to be understood that both the foregoing general description and the following detailed description are by examples, and are intended to provide further explanation of the disclosure as claimed.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a functional block diagram illustrating a device for dropping ball according to an embodiment of the disclosure.

FIG. 2 is a flow diagram illustrating a method for dropping ball according to an embodiment of this disclosure.

FIG. 3A is a schematic diagram illustrating the trigger unit according to an embodiment of this disclosure.

FIG. 3B is a plan view illustrating the round hole according to an embodiment of this disclosure.

FIG. 4A is illustrating the trigger unit according to an embodiment of this disclosure.

FIG. 4B is a plan view illustrating the round hole according to an embodiment of this disclosure.

FIG. 5 is a schematic diagram illustrating a device for dropping ball according to an embodiment of this disclosure.

### DETAILED DESCRIPTION

It will be understood that, in the description herein and throughout the claims that follow, when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Moreover, “electrically connect” or “connect” can further refer to the interoperation or interaction between two or more elements.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, words indicating direction used in the description of the following embodiments, such as “above,” “below,” “left,” “right,” “front” and “back,” are directions as they relate to the accompanying drawings. Therefore, such words indicating direction are used for illustration and do not limit the present disclosure.

It will be understood that, in the description herein and throughout the claims that follow, unless otherwise defined, all terms (including technical and scientific terms) have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any element in a claim that does not explicitly state “means for” performing a specified function, or “step for” performing a specific function, is not to be interpreted as a “means” or “step” clause as specified in 35 U.S.C. § 112(f). In particular, the use of “step of” in the claims herein is not intended to invoke the provisions of 35 U.S.C. § 112(f).

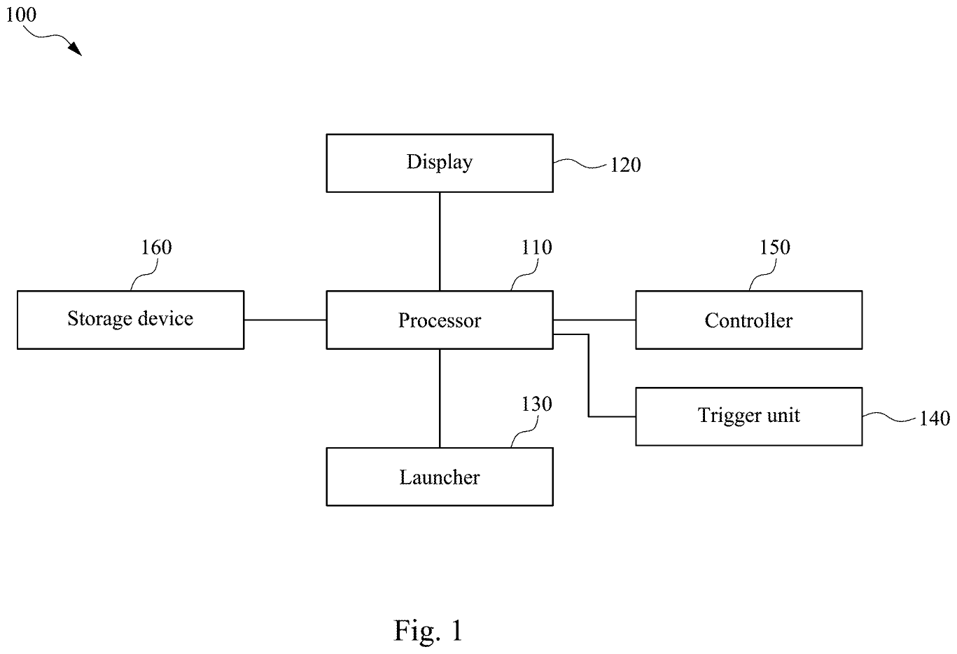

Reference is made to FIG. 1, which is a functional block diagram illustrating a device 100 for dropping ball according to an embodiment of the disclosure. As shown in FIG. 1, the device 100 for dropping ball includes a processor 110, a display 120, a launcher 130, a trigger unit 140, a controller 150 and a storage device 160. The processor 110 is electrically coupled to the display 120, the launcher 130, the trigger unit 140, the controller 150 and the storage device 160. The processor 110 is configured to transmit the control signal to the launcher 130 according to a trigger signal received from the controller 150. The launcher 130 is configured to launch the first ball according to the control signal. When the first ball dropped into a trigger unit 140, the trigger unit 140 is configured to transmit a dropping ball result to the processor 110. The processor 110 is configured to transmit the gameplay frame to the display 120 according to the dropping ball result. The display 120 is configured to display the gameplay frame. The storage device 160 is configured to save the gameplay frame.

In the embodiment, the processor 110 can be implemented by a micro controller, a microprocessor, a digital signal processor, an application specific integrated circuit (ASIC), a logical circuitry or any equivalent circuits of the processor 110. The trigger unit 140 can be implemented by a P-sensor and/or pressure sensor. The storage device 160 can be implemented by a memory, hardware, flash drive, memory card and etc.

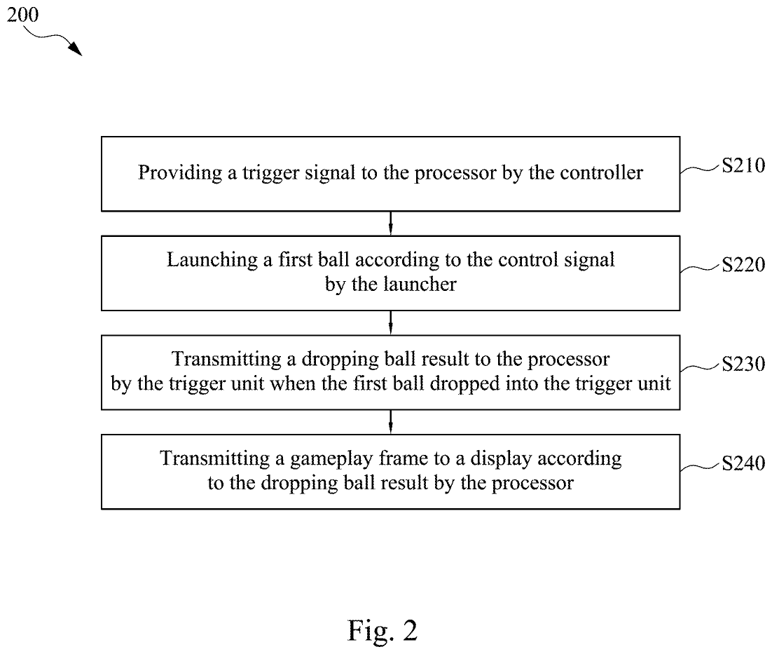

Reference is made to FIG. 2, which is a flow diagram illustrating a method 200 for dropping ball according to an embodiment of this disclosure. In the embodiment, the method 200 for dropping ball is utilized to trigger different gameplay event according to the dropping ball result detected by trigger unit 140, so that the processor 110 transmits different gameplay frame to the display 120.

Reference is made to FIG. 1 and FIG. 2. As the embodiment shown in FIG. 2, the method 200 for dropping ball firstly executes step S210 to provide a trigger signal to the processor 110 by the controller 150. The device 100 for dropping ball includes a controller 150, and the player can press the controller 150 to control the timing of launching ball by the launcher 130. The method 200 for dropping ball further executes the step S220 to launch a first ball according to the control signal by the launcher 130. In the embodiment, the launcher 130 will launch one ball; however the disclosure is not limited thereto. The launcher 130 may launch multiple balls at the same time. In this case, the player may start the game by inputting the tokens or other way.

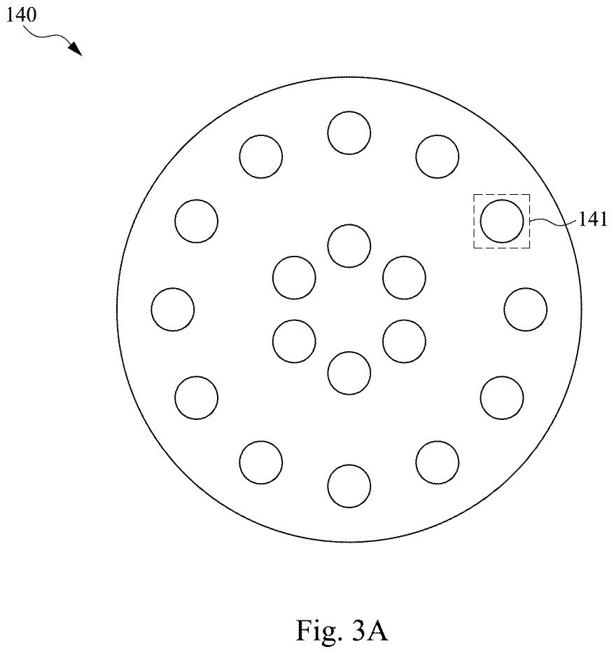

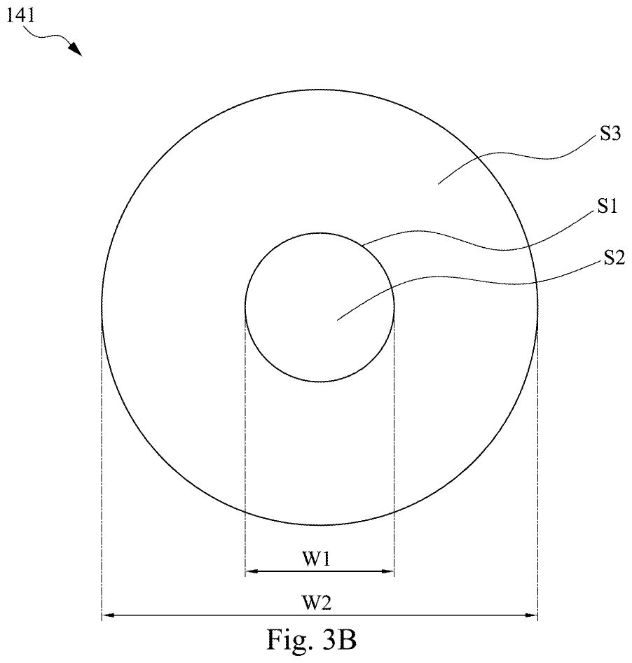

Afterwards, the method 200 for dropping ball executes step S230 to transmit a dropping ball result to the processor 110 by the trigger unit 140 when the first ball dropped into the trigger unit 140. In the embodiment, when the launcher 130 launches the first ball, the first ball will drop into the trigger unit 140. Reference is made to FIG. 3A, which is a schematic diagram illustrating the trigger unit 140 according to an embodiment of this disclosure. In the embodiment as shown in FIG. 3A, the trigger unit 140 can be implemented as a rotatable roulette wheel, wherein the rotatable roulette wheel can rotate with a standard velocity without triggered by special gameplay events. The roulette wheel contains several holes arranged as an inner ring and an outer ring separately. The inner ring contains six round holes and the outer ring contains twelve round holes. As the launcher 130 launches the first ball, the first ball will drop into one of the round hole on the trigger unit 140 in order to trigger certain gameplay events.

Afterwards, reference is made to FIG. 3B, which is a plan view illustrating the round hole 141 according to an embodiment of this disclosure. As shown in FIG. 3B, the round hole 141 contains side wall S1, bottom side S2 and outer frame S3. The outer frame S3 with multiple colors labeled the types of the round holes. The inner ring of outer frame S3 contains the width W1 which allowed a ball rolling in it; the outer ring of outer frame S3 contains the width W2. The trigger unit 140 contains several sensors installed in each side wall S1 and bottom side S2 of round hole in order to detect whether the first ball is dropping into round hole 141 or not. Falling into different round holes will trigger different gameplay events, for example, there would be different game score, game level and etc. The description of round holes 142, 143D and 144 are similar to the round hole 141. For the sake of brevity, those descriptions will not be repeated here.

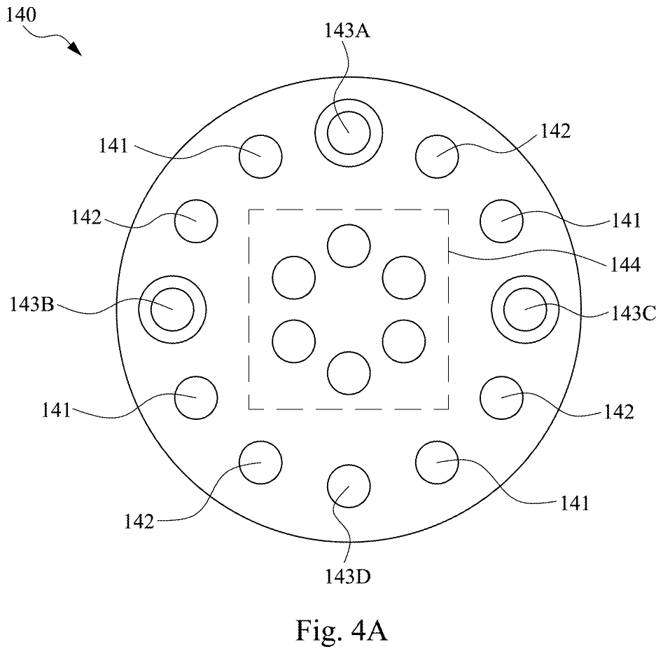

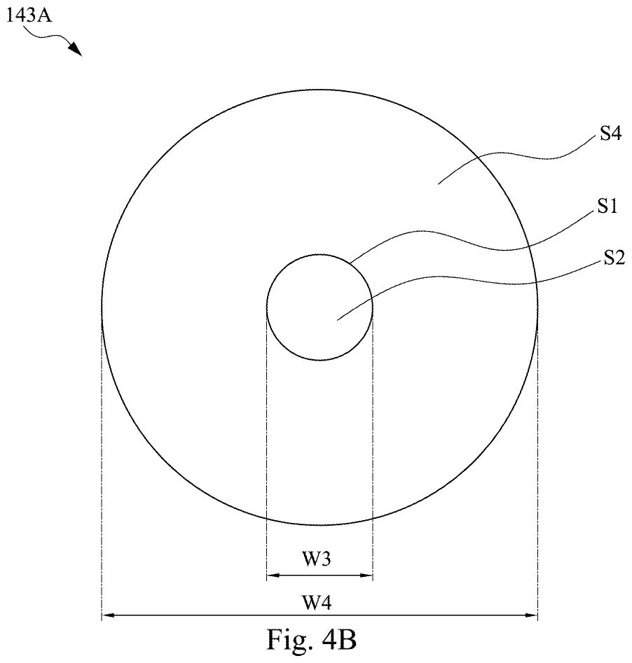

Reference is made to FIG. 4A, which is illustrating the trigger unit 140 according to an embodiment of this disclosure. As shown in FIG. 4A, those round holes on the trigger unit 140 will trigger different gameplay events. For example, when a ball dropped into the round hole 141, the player will gain the corresponding game score, in case the number of triggers accumulate to N times, the players will gain an extra gaming score bonus. The accumulation times “N” can adjust according to the game plot.

Afterwards, the method 200 for dropping ball executes step S240 to transmit a gameplay frame to a display 120 according to the dropping ball result by the processor 110. In the aforesaid embodiment, when a ball dropped into the round hole 141, the processor 110 will be triggered and transmit the gameplay frame to the display 120. When the steps S210, S220, S230 and S240 are all completed, it means the game is ended in one turn and the device 100 for dropping ball will recover the first ball launched for this turn. The player should press the controller 150 again to trigger the launcher 130 to launch the first ball if the player wants to continue the game.

In the embodiment, when the first ball dropped into the round hole 142, the player will gain the corresponding game score. If the number of the round hole 142 triggered is accumulated to N times, the players will gain an extra gaming score bonus. The player will gain the corresponding gaming score if the first ball dropped into the round hole 144. The difference between the round hole 144 and the round holes 141 are 142 is the gaming score may be different or the round hole 144 do not have the function of counting accumulation times or extra gaming score bonus.

In the embodiment, the sensor corresponding to the round hole 143A will detect the first ball dropped into the round hole 143A and generate a dropping ball result corresponding to the round hole 143A to the processor 110. Wherein the dropping result is realized as a sensing signal detected by the sensor corresponding to the round hole 143A. Afterwards, the processor 110 is configured to transmit the control signal to the launcher 130 and trigger the launcher 130 to launch multiple second balls when the processor 110 receives the dropping result correspond to the round hole 143A. The control signal triggered by the round hole 143A will launch multiple second balls through the launcher 130 and as a result of launching multiple second balls, there will be multiple gameplay event triggered. For example, if the sensors corresponding to the round hole 141, 144 and 143B detect the dropping signal of the second ball come from the round hole 141, 144 and 143B, the sensors corresponding to the round hole 141, 144 and 143B will transmit the dropping ball result to the processor 110. The processor 110 will priority execute the gameplay events corresponding to the round hole 141 and 144, and transmit the corresponding gameplay frame to the display 120. The events of the round hole 141 and 144 described previously, and for the sake of brevity, those descriptions will not be repeated here. The amount of the second balls is nine in the embodiment, however the amount of the second balls can adjust according to the difficulty of the game, the disclosure is not limited thereto.

In aforesaid embodiment, the processor 110 further executes the gameplay event corresponding to the round hole 143B. The gameplay event corresponding to the round hole 143B allows the player to manipulate game levels through the controller 150. The processor 110 will display the corresponding gameplay event when the round hole 143B is triggered by the second balls. The player can generate the selecting signal through the controller 150 and the processor 110 will further determine whether execute a specific event or not. For example, the gameplay event corresponding to the round hole 143B may be multiple gaming score or the specific event and that will be triggered by the selecting signal. When the player presses the controller 150, the processor 110 will choose one of the gaming score or the specific event according to the selecting signal. If the specific event has been selected, it will enter to the game level corresponding to the specific event. The gaming score of the specific event is determined by the times player presses the controller 150 during a certain period of time. The more times the player presses, the more gaming score the player gained.

Afterwards, the processor 110 further executes the gameplay event corresponding to the round hole 143, and the gameplay event corresponding to the round hole 143 is to determine whether the ball launched by the player dropped into the same round hole continually or not. The processor 110 is configured to count the number of ball dropping into the round hole and determines whether the number of dropping ball matches the threshold. For example, the player may use the controller 150 to transmit the control signal to the launcher 130 after triggering the gameplay event corresponding to the round hole 143C. If the third ball launched by the launcher 130 dropping into the assigned round hole, the number of dropping ball will add one time and the rotation rate of the trigger unit 140 will increase simultaneously. When the number of dropping ball matches the threshold, it means the player use the controller 150 to drop the ball into the assigned round hole continually, and the player will gain the corresponding gaming score as a reward. In this case, the times of dropping ball ever gain one time, the rotation rate of trigger unit 140 will increase from the default rate. If the number of dropping ball does not match the threshold, the player may gain the corresponding gaming score according to the number of dropping ball. For example, when the number of dropping ball is one, the gaming score is 100; two times and the score is 250; three times the score is 400 and etc. The trigger unit 140 will recover the default rate after gaining the gaming score and it means this game round is over.

Afterwards, one of the first ball or second balls dropped into the round hole 143D will gain higher gaming score compared to the round holes 141, 142 and 144 but will not trigger other gameplay events like the round holes 143A, 143B and 143C. Of course, the round hole 143D can also be designed to have corresponding gameplay events. However, the disclosure is not limited thereto.

From the aforesaid embodiment, the round hole 143A can only be triggered by the first ball; the round holes 143B and 143C can be triggered by the first ball or multiple second balls. Therefore, if the player wants to trigger the special gameplay events corresponding to round holes 143A, 143B and 143C by one ball, the player can control the first ball dropping into the round hole 143A which will launch nine balls after that triggering so those balls may have the opportunity to drop into the round hole 143B and 143C simultaneously. For the reason that the round holes 143B and 143C can be triggered by the first ball or multiple second balls. Reference is made to FIG. 4B, which is a plan view illustrating the round hole 143A according to an embodiment of this disclosure. As shown in FIG. 4B, the round hole 143A contains side wall S1, bottom side S2 and outer frame S3 (not shown in figure). The sensors of the round hole 143A installed in each side wall S1 and bottom side S2 of round hole in order to detect whether the first ball is dropping into round hole 143A or not. The difference between the configuration of the round hole 143A and 141 is that the round hole 143A contains a ring gasket S4 arranged above the frame S4 so that the hole of the round hole 143A not only smaller than the round holes 141, 142, 143D and 144 but also the difference between height of the round hole 143A and the round holes 141, 142, 143D and 144 is height of one ring gasket S4. The inner ring of the ring gasket S4 contains the width S3; the outer ring of the ring gasket S4 contains the width S4. The width of width S3 allows a ball dropping in and smaller than the width S2. This design makes it harder for the ball to drop into the hole 141A than other round holes 141, 142, 143D and 144. The description of round hole 143B and 143C is similar to the round hole 143A, and for the sake of brevity, those descriptions will not be repeated here.

Afterwards, when the gameplay events are all executed, it means the game is ended in one turn and the device 100 for dropping ball will recover the first ball and multiple second balls launched for this turn. If the player wants to play the game again he/she needs to put in a specified amount of tokens to play again. In the embodiment, the controller 150 can be implanted as a button.

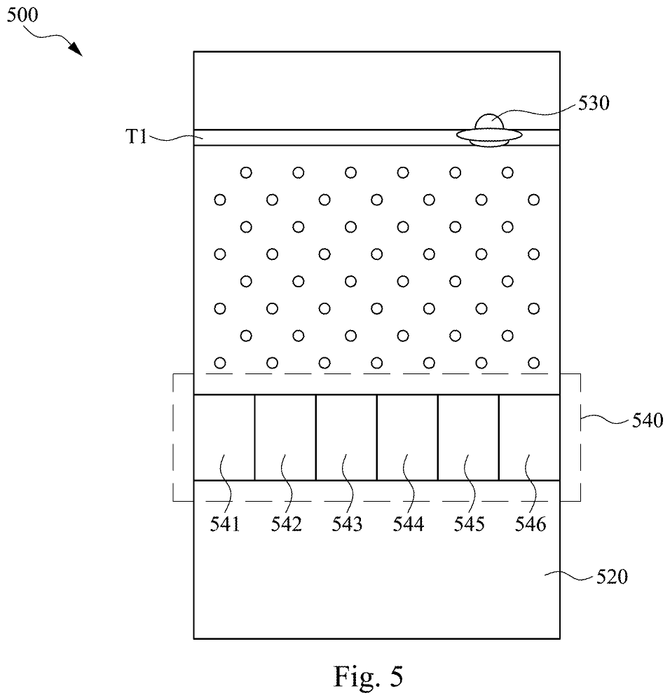

In another embodiment, reference is made to FIG. 5, which is a schematic diagram illustrating a device 500 for dropping ball according to an embodiment of this disclosure. As shown in FIG. 5, the device 500 for dropping ball includes a processor 510 (not shown in figure), a display 520, a launcher 530, a trigger unit 540, a controller 550 (not shown in figure) and a storage device 560 (not shown in figure). The processor 510 is electrically coupled to the display 520, the launcher 530, the trigger unit 540, the controller 550 and the storage device 560. The processor 510 is configured for transmitting the control signal to the launcher 530 according to a trigger signal received from the controller 550. The launcher 530 is configured to launch the first ball according to the control signal and the launcher 530 will move with a constant speed along the track T1. When the first ball dropped into a trigger unit 540, the trigger unit 540 is configured to transmit a dropping ball result to the processor 510. The processor 510 is configured to transmit the gameplay frame to the display 520 according to the dropping ball result. The display 520 is configured to display the gameplay frame and the storage device 560 is configured to save the gameplay frame.

In the embodiment, the player can utilize the controller 550 to control the launcher 530 to launch the ball when the launcher 530 moving to the specific location. The ball will drop into several trigger units 540 which can be implemented as multiple round holes according to the launching site. The sensors installed on each hole transmitted the sensing signal the processor 510. For example, when a ball dropping into the round hole, it will trigger the sensors corresponding to the round hole 541 and transmitted a sensing signal to the processor 510. The processor 510 will display the corresponding gameplay frame after the round hole 541 triggered. The round holes 514-546 may trigger different gameplay events individually and can be designed in different way, the disclosure is not limited thereto.

Another embodiment of the disclosure is a non-transitory computer-readable storage medium. The non-transitory computer readable storage medium stores instructions for performing the method 200 for performing a method for dropping ball in aforesaid embodiment shown in FIG. 2.

Based on aforesaid embodiments, device, method and non-transitory computer-readable medium for dropping ball are capable of triggering a game level in the device through an gaming machine; utilizing the controller and launcher of the gaming machine to combine the game plot will make the dropping ball gaming machine more interesting and attract the consumer with more amusement which will increase the gaming experience for the player.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device for dropping ball, comprising:
a launcher, configured for launching a first ball according to a control signal;
a display, configured for displaying a gameplay frame; and
a processor, electrically coupled to the launcher and the display, configured for transmitting the control signal to the launcher according to a trigger signal;
wherein, the first ball dropped into a trigger unit when the launcher is launches the first ball; the trigger unit is configured to transmit a dropping ball result to the processor, and the processer is configured to transmit the gameplay frame to the display according to the dropping ball result.

2. The device of claim 1, wherein the trigger unit is further comprising:
a controller, electrically coupled to the processor, configured for providing the trigger signal to the processor.

3. The device of claim 2, further comprising:
a first sensor, electrically coupled to the processor, when the first sensor detects the first ball, the first sensor is configured for transmitting a first dropping ball result to the processor; when the processor receives the first dropping ball result, the processor is configured for transmitting the control signal to the launcher to trigger the launcher launches a plurality of second balls.

4. The device of claim 3, further comprising:
a second sensor, electrically coupled to the processor, when the second sensor detects one of the first ball and the plurality of second balls, the second sensor is configured for transmitting a second dropping ball result to the processor; when the processor receives the second dropping ball result, the processor is configured for determining whether to execute a specific event according to a selecting signal.

5. The device of claim 3, further comprising:
a third sensor, electrically coupled to the processor, when the third sensor detects one of the first ball and the plurality of second balls, the third sensor is configured for transmitting a third dropping ball result to the processor; when the processor receives the third dropping ball result, the processor is configured for counting a number of dropping ball, and determining whether the number of dropping ball is matched a threshold.

6. The device of claim 3, further comprising:
a plurality of fourth sensors, electrically coupled to the processor, when the plurality of fourth sensors detects one of the first ball and the plurality of second balls, the processor is configured for calculating a gaming score.

7. A method for dropping ball, comprising:
transmitting a control signal to a launcher according to a trigger signal by a processor;
launching a first ball according to the control signal by the launcher;
when the first ball dropped into a trigger unit, transmitting a dropping ball result to the processor by the trigger unit; and
transmitting a gameplay frame to a display according to the dropping ball result by the processor.

8. The method of claim 7, further comprising:
providing the trigger signal to the processor by a controller.

9. The method of claim 7, the step of when the first ball dropped into the trigger unit, transmitting the dropping ball result to the processor by the trigger unit, further comprising:
detecting whether the first ball by a first sensor;
if the first ball is detected, transmitting a first dropping ball result to the processor by the first sensor;
when the processor receives the first dropping ball result, transmitting the control signal to the launcher by the processor; and
launching a plurality of second balls by the launcher.

10. The method of claim 9, further comprising:
detecting whether one of the first ball and the plurality of second balls by a second sensor;
if one of the first ball and the plurality of second balls is detected, transmitting a second dropping ball result to the processor by the second sensor; and
when the processor receives the second dropping ball result, determining whether to execute a specific event according to a selecting signal.

11. The method of claim 9, further comprising:
detecting whether one of the first ball and the plurality of second balls by a third sensor;
if one of the first ball and the plurality of second balls is detected, transmitting a third dropping ball result to the processor by the third sensor;
when the processor receives the third dropping ball result, counting a number of dropping ball by the processor; and
determining whether the number of dropping ball is matched a threshold.

12. The method of claim 9, further comprising:
detecting whether one of the first ball and the plurality of second balls by a plurality of fourth sensors; and
if one of the first ball and the plurality of second balls is detected, calculating a gaming score by the processor.

13. A non-transitory computer-readable medium including one or more sequences of instructions to be executed by a processor of a device for performing a method for dropping ball, wherein the method comprises:
transmitting a control signal to a launcher according to a trigger signal by a processor;
launching a first ball according to the control signal by the launcher;
when the first ball dropped into a trigger unit, transmitting a dropping ball result to the processor by the trigger unit; and
transmitting a gameplay frame to a display according to the dropping ball result by the processor.

14. The non-transitory computer-readable medium of claim 13, further comprising:
providing the trigger signal to the processor by a controller.

15. The non-transitory computer-readable medium of claim 13, the step of when the first ball dropped into the trigger unit, transmitting the dropping ball result to the processor by the trigger unit, further comprising:
detecting whether the first ball by a first sensor;
if the first ball is detected, transmitting a first dropping ball result to the processor by the first sensor;
when the processor receives the first dropping ball result, transmitting the control signal to the launcher by the processor; and
launching a plurality of second balls by the launcher.

16. The non-transitory computer-readable medium of claim 15, further comprising:
detecting whether one of the first ball and the plurality of second balls by a second sensor;
if one of the first ball and the plurality of second balls is detected, transmitting a second dropping ball result to the processor by the second sensor; and
when the processor receives the second dropping ball result, determining whether to execute a specific event according to a selecting signal.

17. The non-transitory computer-readable medium of claim 15, further comprising:
detecting whether one of the first ball and the plurality of second balls by a third sensor;
if one of the first ball and the plurality of second balls is detected, transmitting a third dropping ball result to the processor by the third sensor;
when the processor receives the third dropping ball result, counting a number of dropping ball by the processor; and
determining whether the number of dropping ball is matched a threshold.

18. The non-transitory computer-readable medium of claim 15, further comprising:
detecting whether one of the first ball and the plurality of second balls by a plurality of fourth sensors; and
if one of the first ball and the plurality of second balls is detected, calculating a gaming score by the processor.
